(19) United States
(12) Patent Application Publication
(10) Pub. No.: US 2016/0048807 A1
(43) Pub. Date: Feb. 18, 2016

(54) EXECUTIVE SEARCH AND RECRUITING TOOL

(71) Applicant: D. A. Kreuter Associates, Inc., Conshohocken, PA (US)

(72) Inventors: Daniel A. Kreuter, Penllyn, PA (US); Steven M. Clark, Wyndmoor, PA (US)

(21) Appl. No.: 14/825,734

(22) Filed: Aug. 13, 2015

Related U.S. Application Data
(60) Provisional application No. 62/036,881, filed on Aug. 13, 2014.

(51) Int. Cl. G06Q 10/10; G06F 17/30

(52) U.S. Cl. CPC G06Q 10/1053; G06F 17/30696

(57) ABSTRACT

A system and method for recruiting that utilizes a combination of pre-categorized and filtered candidate profiles coupled with a discerning search followed by contact with a live representative. A searcher selects candidate criteria as either required or optional. The searcher's selections are compared against a proprietary database of candidate profiles, and are sorted based on the criteria selections of the user. Criteria marked as required are weighted at 100%, while those that do not possess them are weighted at 0%. Criteria marked as optional are weighted at 100%, but if they do not match the candidate the optional criteria are weighted at 50% of the value based upon the number of criteria selected by the searcher. Based on the sorting, the searcher receives a report of qualified candidates ranked by a percentage matched based upon the selected criteria.

### CROSS REFERENCE TO RELATED APPLICATIONS

This application claims priority to U.S. provisional application Ser. No. 62/036,881 filed Aug. 13, 2014, which is incorporated herein by reference in its entirety.

### TECHNOLOGY FIELD

The present invention relates to a web-based executive search and recruiting tool.

### BACKGROUND

Traditional search and recruiting tools are typically built around keyword searching, inputs comprised of random and variable responses, as well as a type of referral mechanism, each with the intent of matching employers with potential new employees. The technology does not provide a searcher with a set of results that includes accurate matching of potential employees with criteria specified by the employer for specific roles within the employer's organization. Instead, a user may get a myriad of unqualified or improperly qualified candidates who have received little to no vetting.

Additionally, traditional computerized search and recruiting tools are only as good as the data structures inherent to their databases. Users who are unfamiliar with a particular recruiting tool may spend many wasted hours because the results procured from their searches lead to candidates who fail to meet the searcher's needs and requirements. However, human recruiters are more dynamic and allow for greater communication between the searcher and the prospective employee, leading to faster hiring times and better qualified candidates that more closely match the needs of the potential employer.

Thus, an executive search and recruiting tool that provides accurate identification of individuals with criteria specified by the employer through a combination of targeted search queries and complementary human aid is desired.

### SUMMARY

Embodiments of the present invention provide for a search and recruiting tool that provides precise identification of candidates with criteria specified by the searcher through the use of targeted search queries and complementary human aid.

In an embodiment, a method of recruiting qualified professionals can use one or more candidate profiles, with each of the candidate profiles having been previously analyzed and assigned criteria by an administrator. The method can receive by a processor from a user interface a selection of criteria from a searcher, wherein a first subset of the criteria is rated as required and a second subset of the criteria is rated as optional; then calculate by the processor a percentage match for each of one or more candidate profiles, stored in a database, each candidate profile associated with a respective candidate, and each percentage match based on the required criteria and the optional criteria. The method can then present by the processor via the user interface data indicative of the plurality of candidate profiles and respective percentage matches.

In an embodiment, a system for recruiting qualified professionals using human interaction combined with a searchable database containing one or more candidate profiles, each of the candidate profiles having been previously analyzed and assigned candidate criteria by an administrator, may include a master database configured to receive one or more candidate profiles, each candidate profile associated with a respective candidate fitting one or more candidate criteria. The system can include a user interface configured to accept a selection of the candidate criteria from a searcher, wherein a first subset of the criteria is rated as required and a second subset of the criteria is rated as optional. The system can also include a processor configured to compare the one or more candidate profiles from the database with the selection of the candidate criteria selected by the searcher; calculate a percentage match for each of the one or more candidate profiles, and generate a table ranking the one or more candidate profiles by the percentage match, configured to display to the searcher via the user interface.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a data flow diagram depicting a recruiting process as initiated by a searcher using a web-based recruiting tool, according to an embodiment;

FIG. 2 is a computer architecture diagram of a web-based recruiting tool, according to an embodiment;

FIG. 3 illustrates various routines and sub-routines for a web-based recruiting tool, according to an embodiment;

FIGS. 4A-4L are screen shots illustrating views from a searcher's perspective of utilizing a web-based recruiting tool, according to an embodiment.

### DETAILED DESCRIPTION

Embodiments are directed to a web-based recruiting tool that enables various industries to identify and connect with individuals that meet specified criteria through a candidate mapping algorithm and interface. Employers who have job openings or other searching needs may utilize the tool to specifically identify function, skills, expertise, credentials, geographic propinquity, and other criteria. Additionally, according to an embodiment, a search consultant supports the process through a hiring event.

In some embodiments, the web-based recruiting tool is directed to the financial services industry, although embodiments are not so limited and may also be used in, for example, the legal industry, the health profession industry, various technology industries, and any other industry in which it is desired to find one or more candidates that meet one or more needs of a searcher. In another embodiment, the web-based recruiting tool can be used as a career service tool in colleges to assist in placement of its graduates. The web-based recruiting tool, in another embodiment, can be used for internal candidate placement at a corporation or organization.

The recruiting tool, in some embodiments, is a website that is hosted on a virtual server. In other embodiments, the website can be hosted on a physical server. The website contains a proprietary master database that connects directly to one or more locally managed proprietary databases and a website database, and is updated at regular intervals (e.g. daily or weekly). In an embodiment, the databases can be created using the SQL database protocol, but other embodiments may utilize Access, Oracle, Lotus, or other known database protocols. The website itself can use PHP, Java, or other known scripting to allow a searcher to interact with the website and the candidate database, as well as to implement the matching algorithm.

The recruiting tool candidate database can be segmented into several redundant databases. A master database, located on a centralized server or in the cloud, can serve as the reference and aggregate database containing all proprietary information and candidate profiles. Multiple locally managed databases, located at one or more locations, can be used for the entry of data by the administrators of the recruiting tool. The locally managed databases can synchronize with the master database at prescribed intervals (e.g. daily or weekly) such that the master database can contain the complete list of candidate profiles entered from all locally managed proprietary databases. In order to interact with the user interface, a read-only website database can synch with the master database to populate candidate profiles for a search. Read-only denotes that the website database can have the ability to read information from the master database, but does not have the ability to write data to the master database. The read-only prohibition can add a layer of protection to prevent unwanted corruption of the master database. In an alternate embodiment the website database can have write permissions as well as read permissions. Due to the proprietary nature of the candidate profiles and associated information, the master database, locally managed databases, and website database can be encrypted to prevent unauthorized access.

The candidate database includes a plurality of candidate profiles. The data that comprises the candidate profiles is ported to the user interface through the candidate database, allowing perspective clients and searchers to filter the candidate profiles, which, in some embodiments may encompass tens of thousands of records, to help in their decision to engage in an actual search, having validated the number of potential candidates that may fit their specific opening. Additional mechanisms and processes allow for the clients to engage in a candidate search utilizing various aspects of ecommerce: a chat room, a service desk, and a complete online process for selection, evaluation, interviewing, negotiating, position offering, and onboarding.

A candidate profile can contain a variety of information. In some embodiments, the candidate profile can be associated with a candidate identification (ID) number that can be used to quickly identify the associated candidate. The candidate profile can include an itemization of the criteria the candidate qualifies for. The itemization can be created through examination of the candidate's resume or by manual entry from an administrator of the recruiting tool. The administrator may adjust the itemized criteria within the candidate profile after communicating with the candidate, and may do so by altering the candidate profile through a locally managed database, which in turn will synchronize with the master database. An administrator can alter what is considered to be defined as criteria through interaction with one of the databases. This change to the definition can be propagated throughout the system, such that all databases and all candidate profiles share the same definitions of criteria, in order for the recruiting tool to remain stable and without corruption.

In an embodiment, a new candidate profile can be generated as follows: a recruiting tool administrator can input basic information about the candidate, including name, address, and contact information. Based upon the candidate's resume or from personal interactions, the administrator can input details regarding the candidate's work history and other assorted employment information. The administrator can then match the candidates information to the respective criteria designated as searchable by a searcher, such that when a searcher selects as required or optional a certain criterion that the candidate possesses, the candidate will appear somewhere on the percentage matched list. Thus, each new candidate is pre-categorized by the recruiting tool administrators based upon their work history and employment requirements when they are entered as new potential employees. A recruiting tool administrator may update the candidate's criteria as the candidate's employment status and abilities change.

In some embodiments, when using the web-based recruiting tool, a searcher creates an account to be able to access the criteria selection page. In an embodiment, the creation of an account and preliminary searches can be free of charge. After selecting criteria in a plurality of different subsections, choosing the criteria as either required (“Must Have”) or optional (“Nice to Have”), the search is submitted and the searcher is presented with a “Percentage Match” page. The algorithm runs on the selected criteria, with matches for required (“Must Have”) criteria being worth 100% if a match and 0% if not a match for that criteria; matches for optional (“Nice to Have”) criteria are worth 100% if a match, and if not a match are 50% of the value of the total criteria selected. The “Percentage Match” page provides the user with a visual of the results, broken down by the number of candidates matching at a given percentage.

After electing to move forward with the process, the user may, in some embodiments, formally submit a search to the web-based recruiting tool by, according to an embodiment, purchasing and submitting a search credit via the website. The searcher may then, according to an embodiment, receive a phone call (or other communication) to discuss the role in detail, allowing a consultation off-line, giving the process a “human element”. In an embodiment, the consultation can be conducted through the user interface itself The consultation helps define a more specific and precise search strategy, typically: reviewing compensation ranges; defining more specific skill set requirements, position responsibilities and goals; finalizing profiles desired; and noting any technical skills required. This, in combination with any written material that may be submitted by a candidate, helps provide more accurate results to the searcher. The vetting and validation process may be done through email, a web-based portal, the user interface, or other electronic means to qualify that the role, location, and compensation of the position are acceptable to the candidate, and that the candidate has the skill set that was determined during the interface between the searcher and the consultant.

Advantages of the web-based recruiting tool include: the ability to access a “hidden” candidate pool—not just people unemployed or actively looking for jobs; candidates are vetted and validated before being presented to the client for a specific hiring need; the ability to benchmark internal candidates against external candidates for any position opening; and allowing perspective employers to target candidates with pin-point accuracy. Moreover, the addition of the live consultation services can present a searcher with a deeper, more personalized recruitment tool that returns less unhelpful information or unqualified candidates, saving the searcher time and resources. The benchmarking of internal versus external candidates is accomplished by presenting qualified candidates that may result in the searcher making a more educated decision on hiring an internal candidate or finding a superior candidate that is external to the organization.

The following is a real use case of the web-based recruiting tool: A major global bank's asset management arm had openings for Sales Specialists to act as wholesale intermediaries between their ETF (exchange-traded fund) manufacturing group and the investment advisor community, notably major wirehouses. They were seeking qualified candidates who understood the application of ETFs in investment portfolios and who had wirehouse contacts in specific geographical territories (Pacific Northwest/Great Lakes). Unable to identify an appropriate candidate pool through their own internal resources, the global bank used the web-based recruiting tool according to embodiments herein, was able to identify several on-point candidates, and extended offers for each territory, filling these critical openings in a matter of weeks.

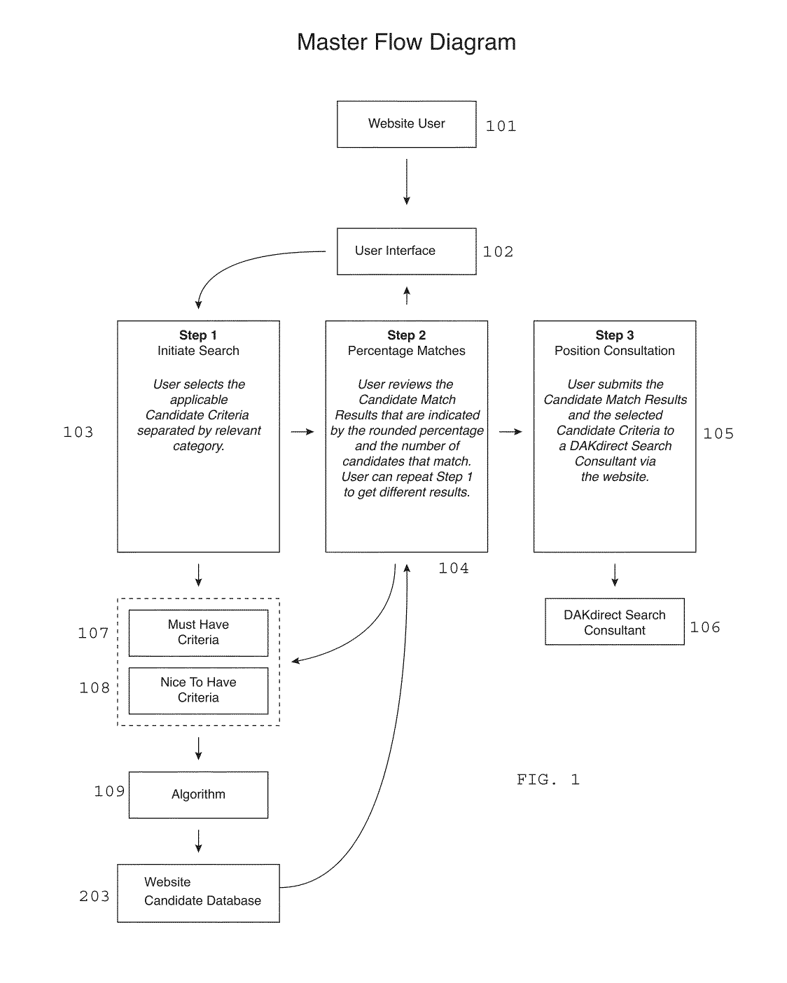

FIG. 1 is a data flow diagram depicting a data flow for a recruiting process as initiated by a searcher using the web-based recruiting tool, according to embodiments provided herein. The website user (i.e., the searcher) 101 accesses the website via a user interface 102 and initiates the search (Step 1 103) by selecting the desired candidate criteria. In some embodiments, the searcher is presented with various categories, with the selection of desired candidate criteria being made in each of the various categories. According to an embodiment, the selection of criteria includes an indication of required (“Must Have”) criteria 107 (meaning the searcher views the associated criterion as essential or required) or optional (“Nice to Have”) criteria 108 (meaning the searcher views the associated criterion as optional but still desirable).

An algorithm 109 compares the selected criteria with candidate profiles located on the website database 203, with matches for required (“Must Have”) criteria 107 being worth 100% if a match, and 0% if not a match for that criteria; matches for optional (“Nice to Have”) criteria 108 being worth 100% if a match, and if not a match are 50% of the value of the total criteria selected.

The next step of the data flow (Step 2 104) is the searcher being presented with search results in the form of percentage matches. According to an embodiment, the algorithm 109 is used to determine a percentage match for each of a plurality of candidate profiles, the algorithm 109 taking into account the searcher's selection of required (“Must Have”) criteria and optional (“Nice to Have”) criteria, as well as the candidate profiles from the website candidate database 203. The “Percentage Match” page provides the searcher with a visual of the results, broken down by the number of candidates matching at a given percentage. The searcher is presented with the results, sorted, according to an embodiment, from highest to lowest percentage match, indicating the number of candidates with each percentage match. In an embodiment, the percentage matches can be rounded to a preset number of significant figures for clarity of display.

Step 3 105 of the data flow comprises the searcher submitting the search results, along with searcher's selected criteria, which results in a consultation 105 with a live representative/specialist 106 to, for example, review the results and discuss strategies for candidate selection. In another embodiment, the searcher may bypass the consultation 105 and simply use the search results to contact desired candidates. In an embodiment, performing Steps 1 through 3 can be conducted free of charge.

After electing to move forward with the process, the searcher may, in some embodiments, formally submit a search to the web-based recruiting tool by, according to an embodiment, purchasing and submitting a search credit via the website. The searcher may then, according to an embodiment, receive a phone call (or other communication) to discuss the role in detail, allowing a consultation 105 off-line, giving the process a “human element”. In an embodiment, the consultation 105 can be conducted through the user interface itself. The consultation 105 with a trained service professional helps define a more specific and precise search strategy, typically: reviewing compensation ranges; defining more specific skill set requirements, position responsibilities and goals; finalizing profiles desired; and noting any technical skills required. This, in combination with any written material that may be submitted by a candidate, helps provide more accurate results to the searcher.

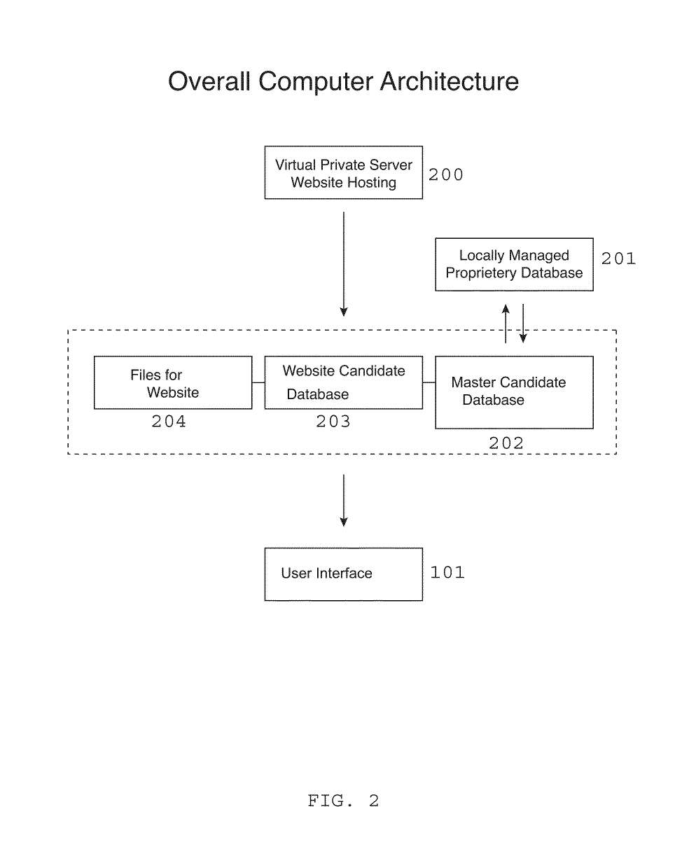

FIG. 2 is a computer architecture diagram of the web-based recruiting tool, according to an embodiment. As noted above, the recruiting tool may be a website that is hosted on a virtual server 200. In other embodiments, the website can be hosted on a physical server (not shown). The website utilizes a website database 203 connected to a master database 202 that in turn connects directly to one or more locally managed proprietary databases 201, all updated at regular intervals (e.g. daily or weekly). In an embodiment, the databases can be created using the SQL database protocol, but other embodiments may utilize Access, Oracle, Lotus, or other known database protocols. The website itself can use PHP, Java, or other known scripting to allow a searcher to interact with the website and the candidate database. The files for the website 204 are the code interpreted and executed by the server to implement the algorithm, the results of which are part of the generated page indicating the percentage matches displayed on the user interface 101.

The recruiting tool candidate database can be segmented into several redundant databases. A master database 202, located on a centralized server or in the cloud, can serve as the reference and aggregate database containing all proprietary information and candidate profiles. Multiple locally managed databases 201, located at one or more locations, can be used for the entry of candidate data by the administrators of the recruiting tool. The locally managed databases 201 can synchronize with the master database 202 at prescribed intervals (e.g. daily or weekly) such that the master database 22 can contain the complete list of candidate profiles entered from all locally managed proprietary databases 201. In order to interact with the user interface 101, a read-only website database 203 can synch with the master database 202 to populate candidate profiles for a search. Read-only denotes that the website database 203 can have the ability to read information from the master database 202, but does not have the ability to write data to the master database 202. The read-only prohibition can add a layer of protection to prevent unwanted corruption of the master database 202. Due to the proprietary nature of the candidate profiles and associated information, the master database 202, locally managed databases 201, and website database 203 can be encrypted to prevent unauthorized access.

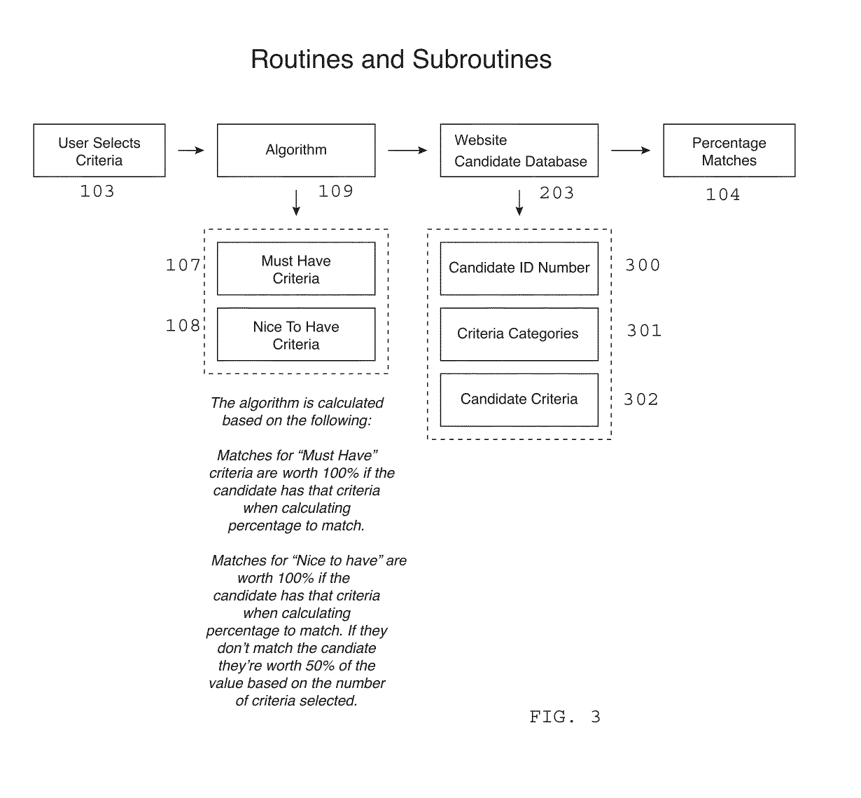

FIG. 3 illustrates various routines and subroutines for the web-based recruiting tool, according to an embodiment. The searcher selects the candidate criteria 103, identifying each as required (“Must Have”) 107 or optional (“Nice to Have”) 108, and the algorithm 109 is run, taking into account the selection and identification of the criteria by the searcher. The website candidate database 203, which, as noted above, contains a plurality of candidate profiles (containing, e.g., candidate identification numbers and candidate criteria), is accessed to determine a percentage match for each candidate.

A candidate profile can contain a variety of information. In some embodiments, the candidate profile can be associated with a candidate identification (ID) number 300, which can be used to quickly identify the associated candidate. The candidate profile can include an itemization of the criteria the candidate qualifies for 302. The itemization can be created through examination of the candidate's resume or by manual entry from an administrator of the recruiting tool. The administrator may adjust the itemized criteria 302 within the candidate profile after communicating with the candidate, and may do so by altering the candidate profile through a locally managed database, which will in turn synchronize with the master database. An administrator can alter criteria categories 301 through interaction with one of the databases. This change to the categories 301 can be propagated throughout the system, such that all databases and all candidate profiles share the same definitions of criteria 301, in order for the recruiting tool to remain stable and without corruption.

In an embodiment, a new candidate profile can be generated as follows: a recruiting tool administrator can input basic information about the candidate, including name, address, and contact information. Based upon the candidate's resume or from personal interactions, the administrator can input details regarding the candidate's work history and other assorted employment information. The administrator can then match the candidates information to the respective criteria designated as searchable by a searcher, such that when a searcher selects as required or optional a certain criterion that the candidate possesses, the candidate will appear somewhere on the percentage matched list. Thus, each new candidate is pre-categorized by the recruiting tool administrators based upon their work history and employment requirements when they are entered as new potential employees. A recruiting tool administrator may update the candidate's criteria as the candidate's employment status and abilities change.

In an embodiment, the searcher can select the criteria 302 through a user interface, which can be graphical in nature. The criteria can be categorized generally into, but are not limited to, six groups: function, environment, product, distribution, qualifications, and location. The list of categories 301 can be changed to fit the particular industry, and the categories can be further subdivided into subcategories for further precision searching. Additionally, the user interface can contain pop-out boxes that provide a written description of the criteria. Through the user interface, the searcher can select the categorized criteria 302 by selecting or deselecting check boxes. A searcher cannot delineate that a particular criteria is both required and optional.

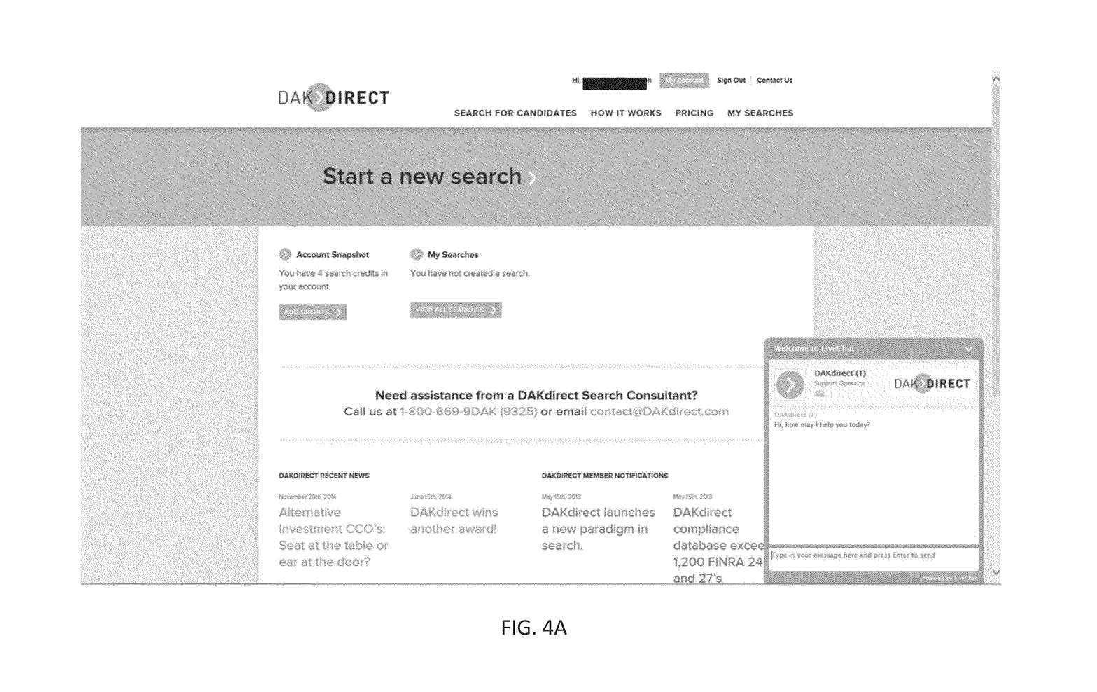

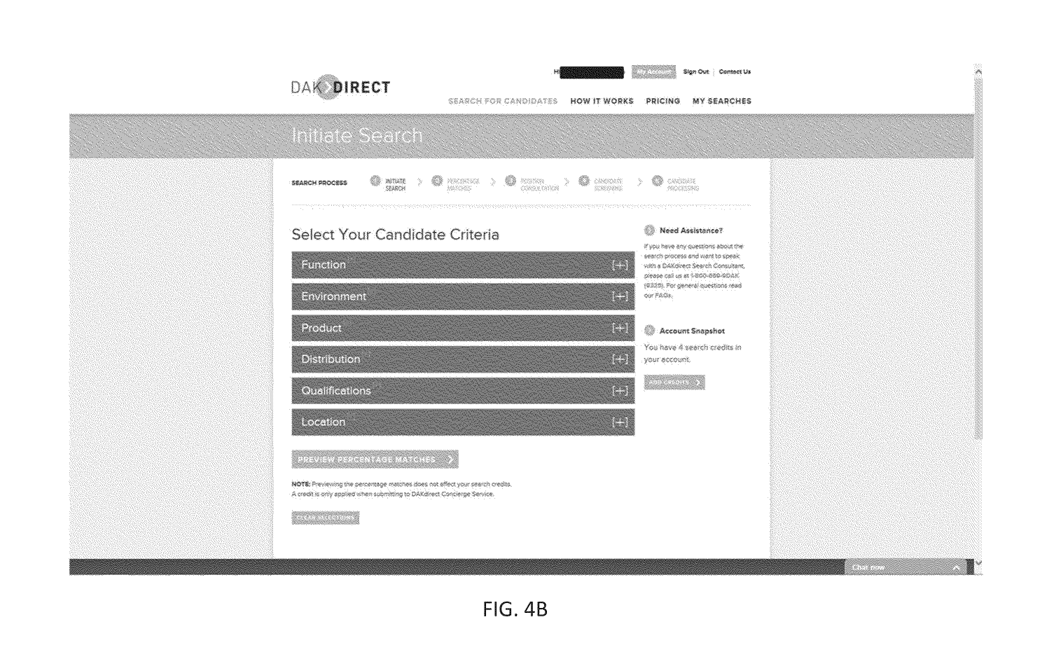

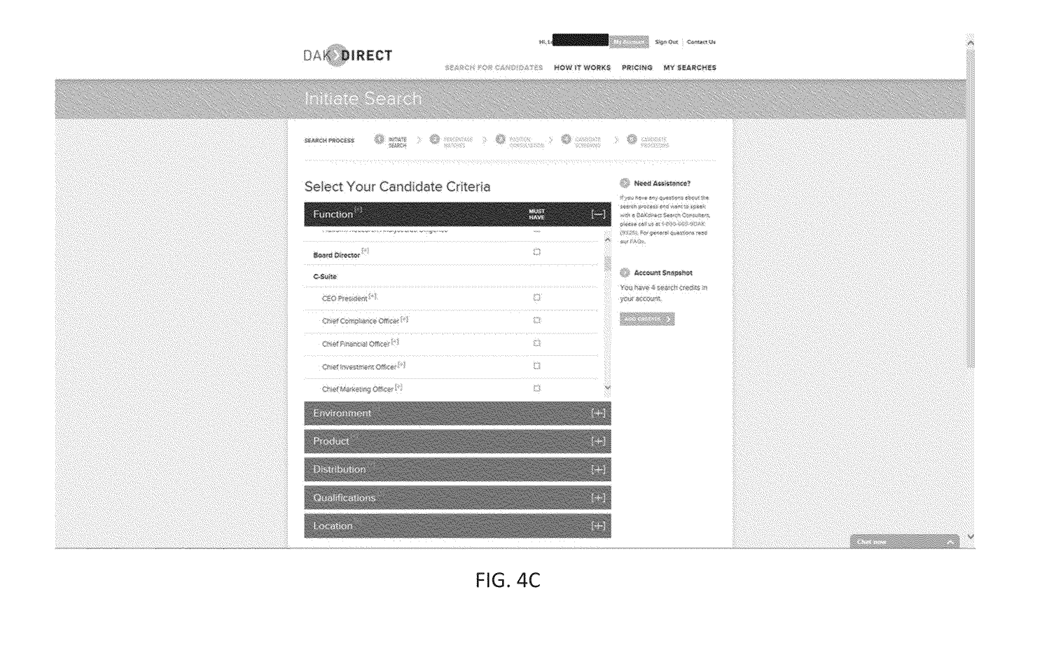

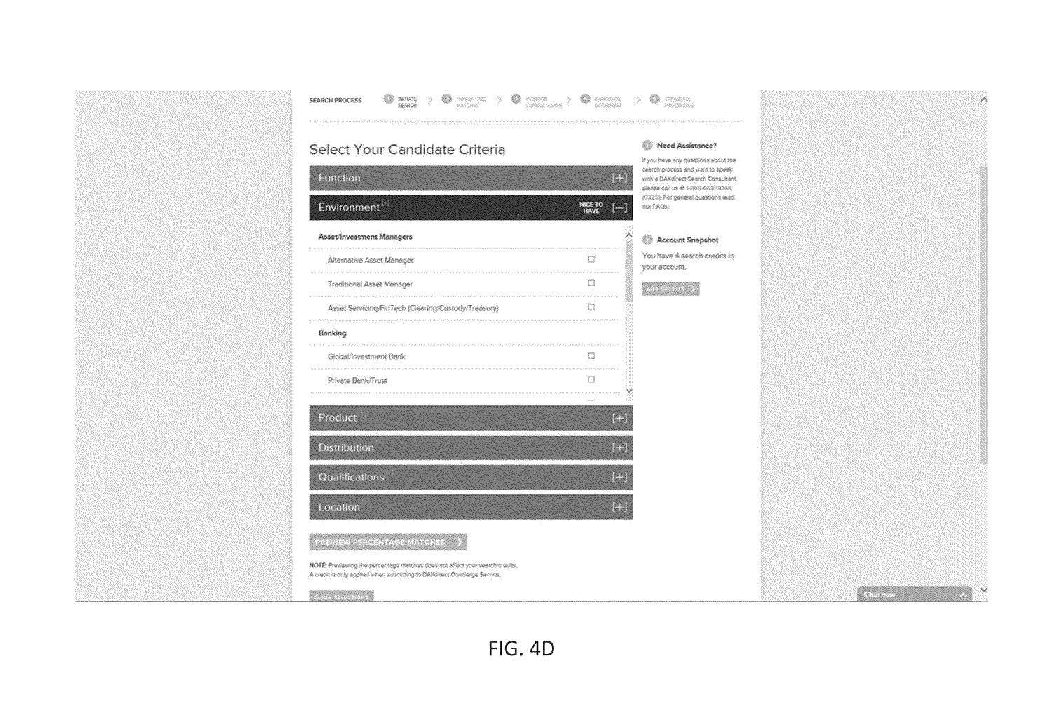

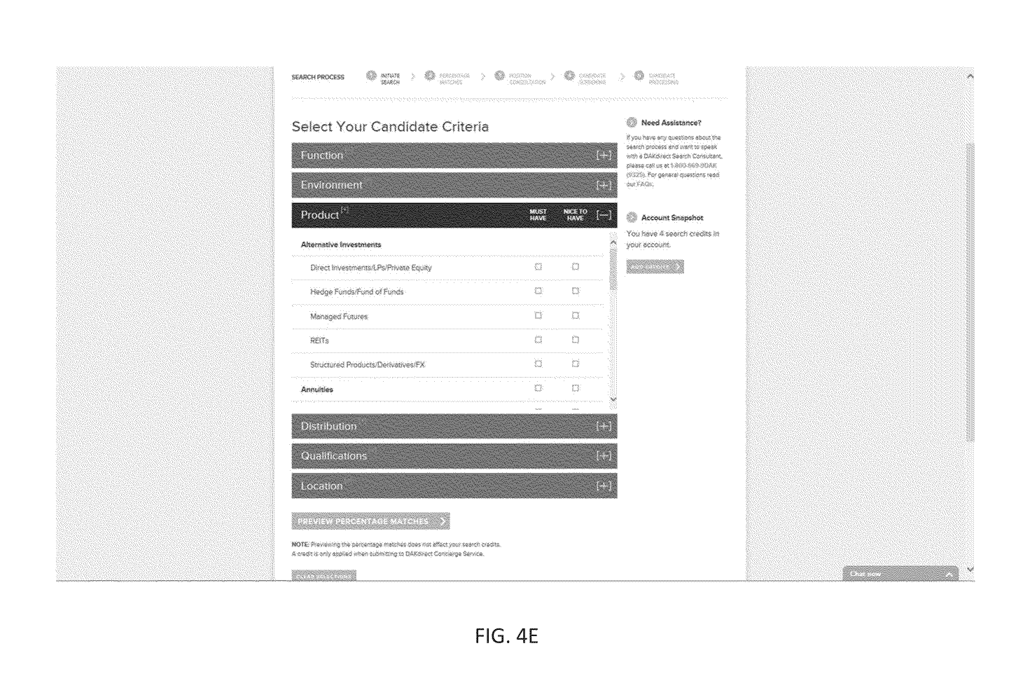

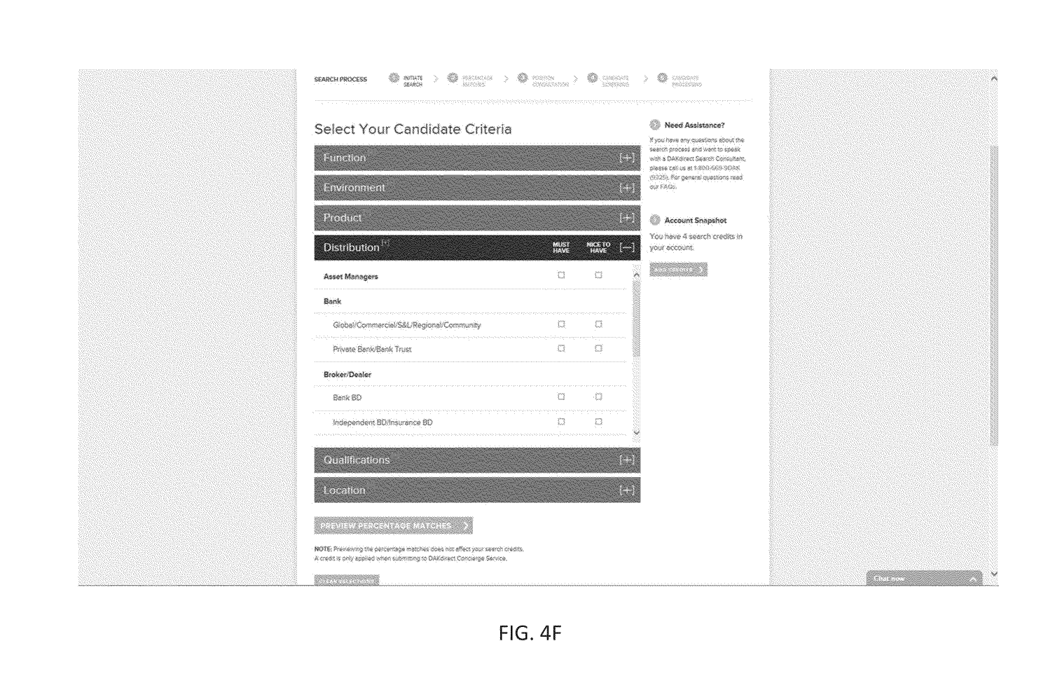

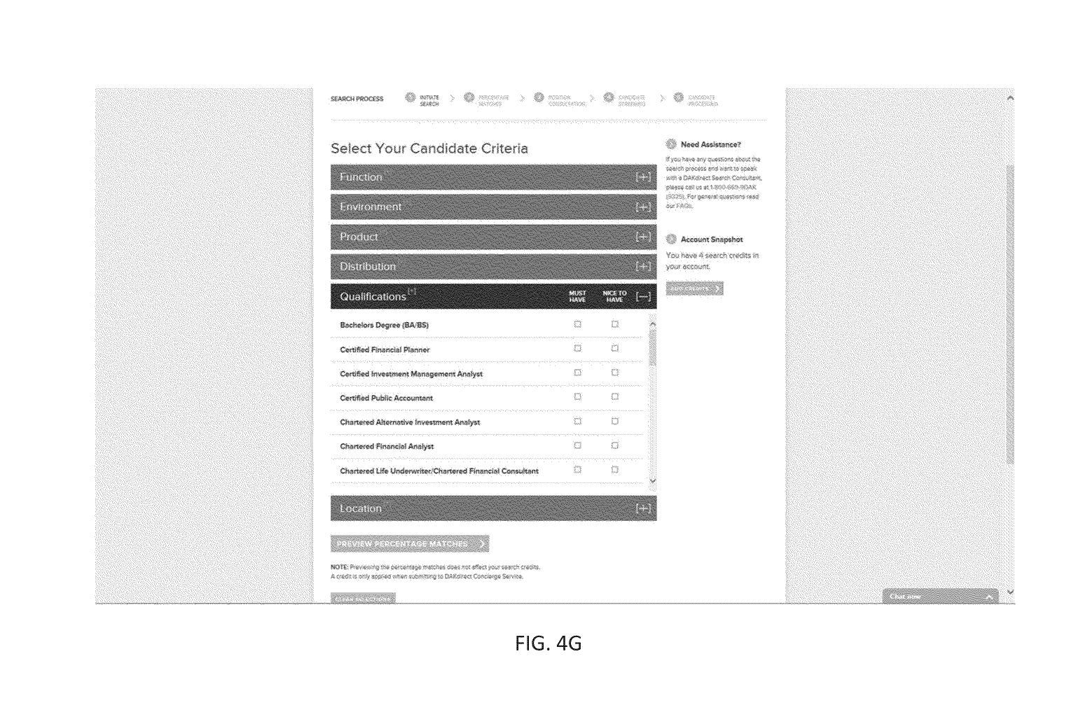

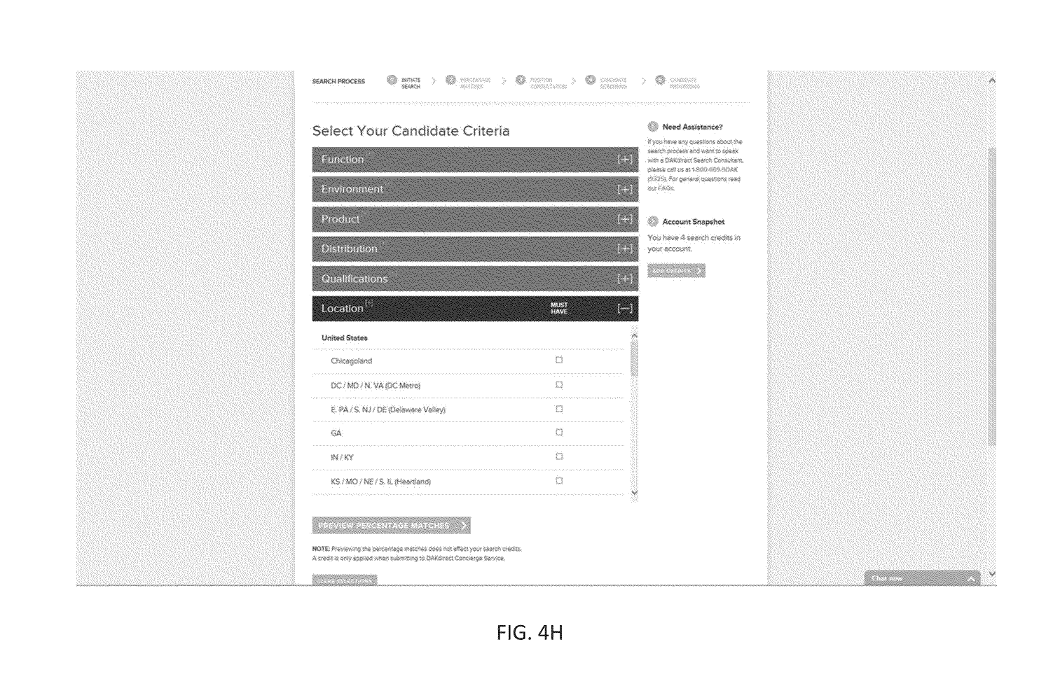

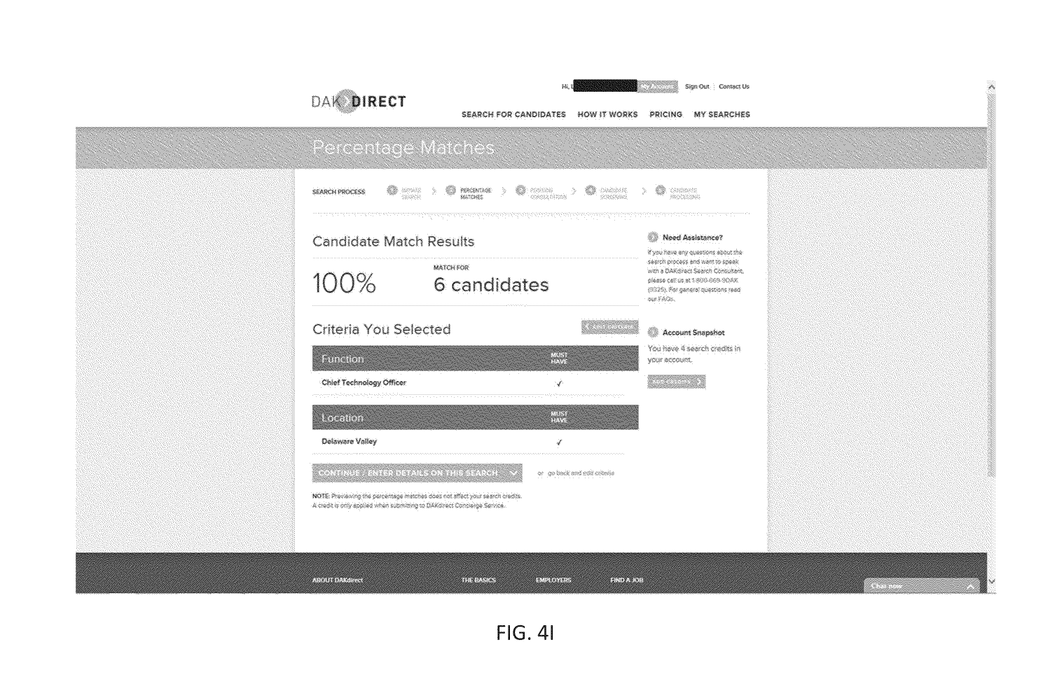

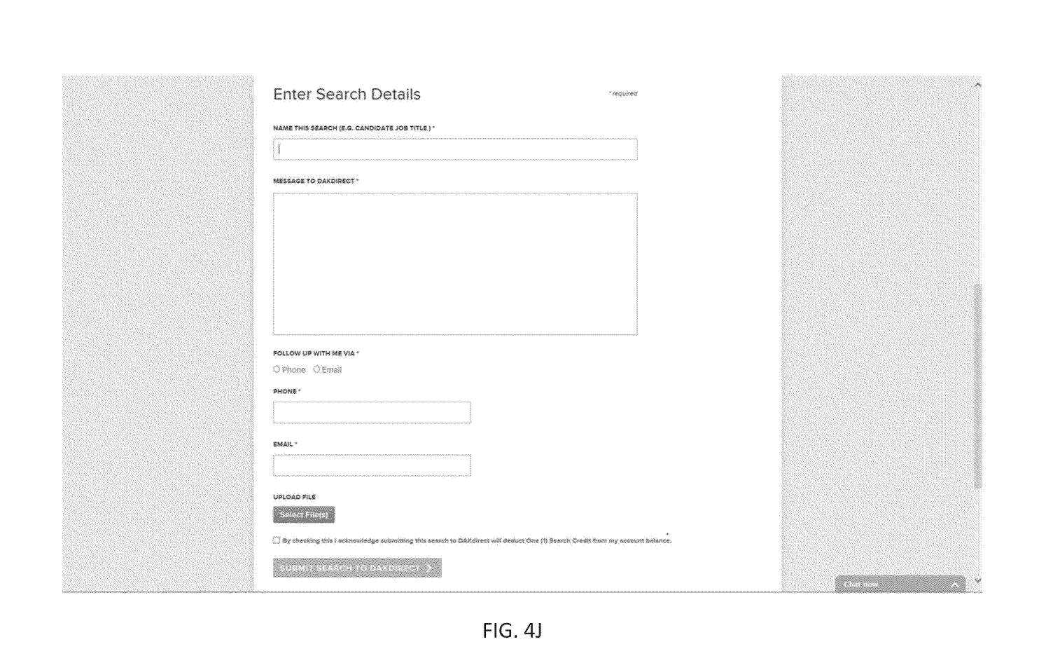

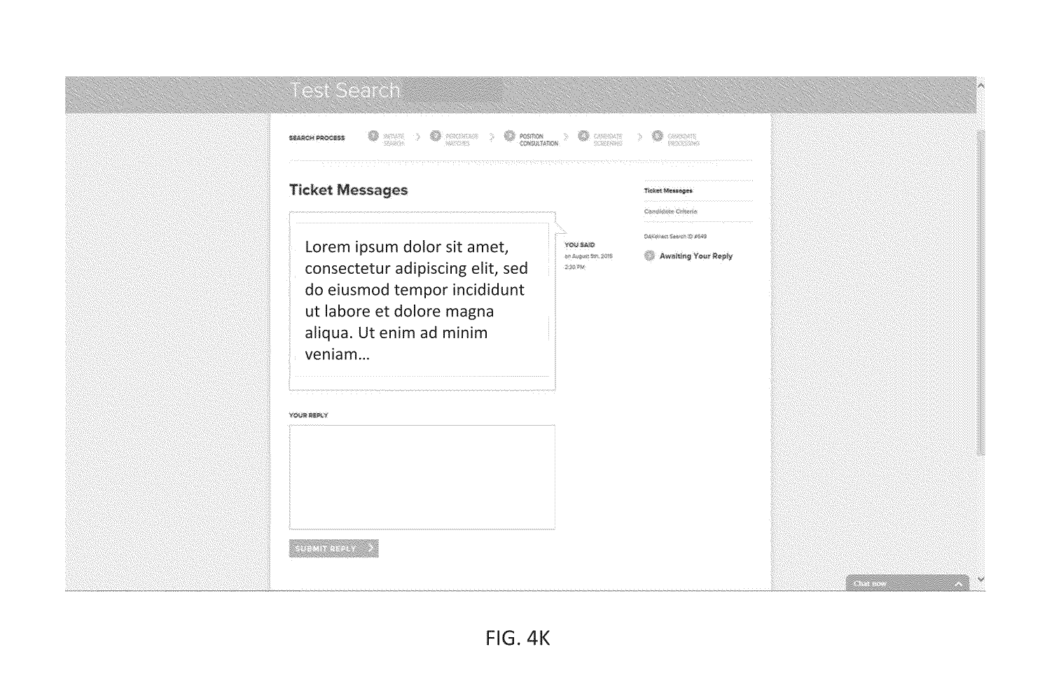

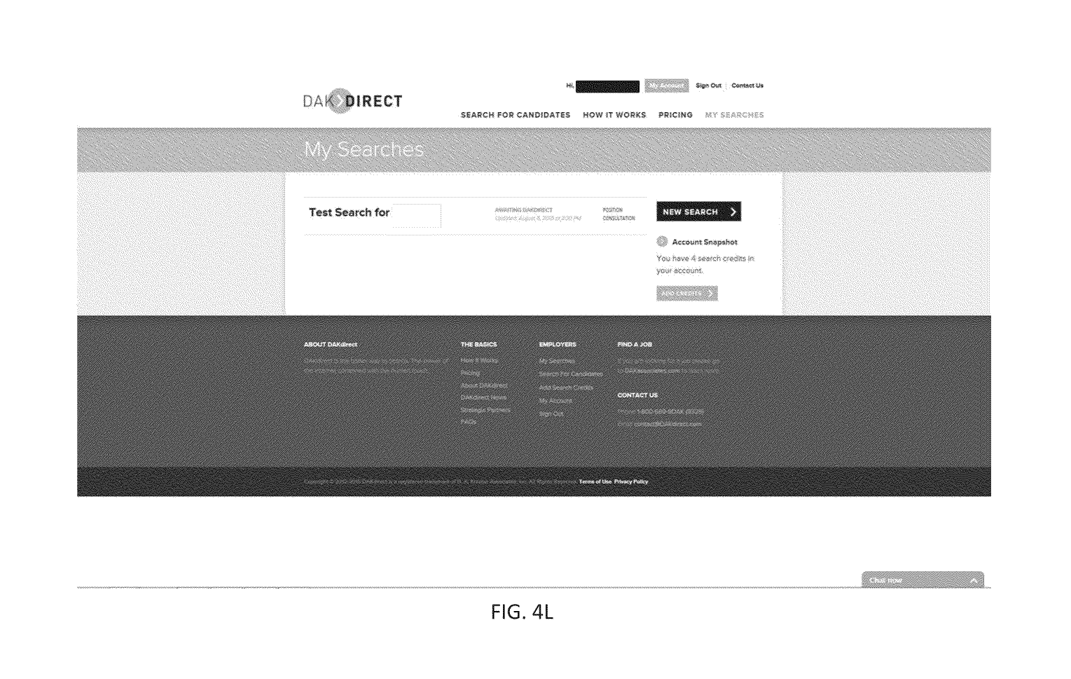

FIGS. 4A-4L are a series of screen shots illustrating views from a searcher's perspective of utilizing the web-based recruiting tool, according to embodiments provided herein. FIG. 4A illustrates an account page for a searcher, showing the searcher's remaining search credit, and providing a link to any active searches or previous searches the searcher has conducted. Additionally, the figure illustrates a live chat pop-up window that can display automatically when the searcher visits the user interface. During business hours, the live chat window can provide a searcher instant access to a recruiter tool administrator, who can aid the searcher with the employee search. In an embodiment, any message entered into the chat window after normal business hours can route to a message box for later reply. FIGS. 4B-4H illustrate a selection of candidate criteria (function, environment, product, distribution, qualifications, and location), according to an embodiment. In an embodiment, the selection can be done via check boxes. FIG. 4I illustrates a percentage match page, according to an embodiment. FIG. 4J illustrates features relating to a potential submission of the search, which may, in some embodiments, result in a personal consultation with a representative for a follow-up to the criteria selection aiding in the overall candidate search. A searcher can title the search, input a message for the live consultation, select a method of preferred communication, provide contact information, file any supplemental documentation, and submit the search. FIG. 4K illustrates a ticketed messages page that can display after the searcher enters the search details on the page shown in FIG. 4J. In an embodiment, a submitted search can be assigned an internal tracking number. The recruitment tool administrator can respond to the searcher's message through the ticketing system, or can contact the searcher via telephone, email, or other communication method. FIG. 4L illustrates a “My Searches” page for a searcher that can list any currently active employee searches, as well as provide links and status updates to those searches. The page also provides a link to begin a new search and replenish search credit.

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A method of recruiting qualified professionals using one or more candidate profiles, each of the candidate profiles having been previously analyzed and assigned criteria by an administrator, using a processor and a user interface, the method comprising:
receiving by a processor from a user interface a selection of criteria from a searcher, wherein a first subset of the criteria is rated as required and a second subset of the criteria is rated as optional;
calculating by the processor a percentage match for each of one or more candidate profiles, from a plurality of candidate profiles stored in a database, each candidate profile associated with a respective candidate, and each percentage match based on the required criteria and the optional criteria; and
presenting by the processor via the user interface data indicative of the plurality of candidate profiles and respective percentage matches.

2. The method of claim 1, wherein each percentage match is comprised of: 100% for each required criteria possessed by the respective candidate; 0% for each required criteria not possessed by the respective candidate; 100% for each optional criteria possessed by the respective candidate; where the optional criteria are 50% of a value of the total criteria selected.

3. The method of claim 1, wherein the criteria comprises one or more of: function, education, skills, expertise, qualifications, and geographic propinquity.

4. The method of claim 1, the method further comprising:
receiving by the processor from the user interface a request of a consultation from the searcher; and
forwarding by the processor the request of the consultation to a representative.

5. The method of claim 4, wherein the consultation to the representative further narrows the user interface data into one or more perspective employment candidates.

6. The method of claim 1, further comprising:
contacting a member of the plurality of candidate profiles via the user interface.

7. A system for recruiting qualified professionals using human interaction combined with a searchable database containing one or more candidate profiles, each of the candidate profiles having been previously analyzed and assigned candidate criteria by an administrator, comprising:
a master database configured to receive one or more candidate profiles, each candidate profile associated with a respective candidate fitting one or more candidate criteria;
a user interface configured to accept a selection of the candidate criteria from a searcher, wherein a first subset of the criteria is rated as required and a second subset of the criteria is rated as optional, and;
a processor configured to:
compare the one or more candidate profiles from the database with the selection of the candidate criteria selected by the searcher;
calculate a percentage match for each of the one or more candidate profiles, and;
generate a table ranking the one or more candidate profiles by the percentage match, configured to display to the searcher via the user interface.

8. The system of claim 7, wherein each percentage match is comprised of: 100% for each required criteria possessed by the respective candidate; 0% for each required criteria not possessed by the respective candidate; 100% for each optional criteria possessed by the respective candidate; where the optional criteria are 50% of a value of the total criteria selected.

9. The system of claim 7, wherein the criteria comprises one or more of: function, education, skills, expertise, qualifications, and geographic propinquity.

10. The system of claim 7, wherein the master database is further configured to update one or more candidate profiles from one or more locally managed databases.

11. The system of claim 7, wherein the user interface is further configured to connect the searcher to a live representative.

12. The system of claim 11, wherein the connection to a live representative occurs without input from the searcher.

13. The system of claim 11, wherein the live representative is a trained search professional.

14. The system of claim 7, wherein the master database is further configured to receive a resume for each of the one or more candidate profiles.

15. The system of claim 7, wherein the user interface is further configured to connect the searcher to the representative candidate associated with the respective candidate profile.

16. The system of claim 7, further comprising a website database;
wherein the website database is configured to obtain one or more candidate profiles from the master database.

17. The system of claim 16, wherein the website database obtains the one or more candidate profiles from the master database as read-only.

18. The system of claim 7, wherein the master database, the user interface, and the processor are hosted on a virtual server.
